(19) United States
(12) Patent Application Publication
(10) Pub. No.: US 2007/0070940 A1
(43) Pub. Date: Mar. 29, 2007

(54) COMMUNICATIONS EVENT SCHEDULER

(75) Inventors: Raymond Vander Veen, Waterloo (CA); Neil Adams, Waterloo (CA); Sorel Bosan, Toronto (CA); Thanh Vuong, Kitchener (CA)

Correspondence Address: RIDOUT & MAYBEE;SUITE 2400, ONE QUEEN STREET EAST, TORONTO, ON, M5C3B1, CA

(73) Assignee: RESEARCH IN MOTION LIMITED, Waterloo (CA)

(21) Appl. No.: 11/535,337

(22) Filed: Sep. 26, 2006

Related U.S. Application Data
(60) Provisional application No. 60/720,055, filed on Sep. 26, 2005.

(51) Int. Cl. H04Q 7/00

(52) U.S. Cl. 370/328

(57) ABSTRACT

Scheduling communications events on an electronic communications device, including (i) storing information about a future communications event, the stored information including stored address information identifying an address of the target recipient and stored time information identifying a scheduled time for the future communications event; (ii) displaying on a display of the communications device, at a time determined in dependence on the stored time information, a notification of the future communications event; (iii) monitoring for a confirmation input through a user input device confirming a user desire to proceed with the future communications event; and (iv) automatically providing the address for the target recipient to the communications module in dependence on the stored address information upon detecting the confirmation input.

The Application claims priority to U.S. Provisional Patent Application No. 60/720,055 filed Sep. 26, 2006.

### FIELD OF THE INVENTION

Example embodiments described herein relate to communications devices and, in particular, to methods and systems for scheduling and carrying out communications events on such devices.

### BACKGROUND OF THE INVENTION

Communications devices, in particular handheld mobile communications devices, are becoming increasingly sophisticated. A common feature of such communications devices is a system or application for scheduling meetings and setting reminders, i.e. a built-in calendar or events scheduler.

It is common for a communications device user to need to communicate with another party at a later time, perhaps at a specific date/time, and it can be difficult to remember to do so. For example, a user may need to remember toemail or call someone on their birthday, or to email or call to schedule a doctor's appointment. An event scheduling application such as a calendar application can be used to remind the user to make a call to email or to otherwise contact someone in the future.

### BRIEF DESCRIPTION OF THE DRAWINGS

Example embodiments will now be described by way of example with reference to the accompanying drawings, through which like reference numerals are used to indicate similar features.

FIG. 1 shows a block diagram of an example of a mobile communications device to which example embodiments of a communications event scheduler can be applied;

FIG. 2 shows, in diagrammatic form, a front view of an example of the device of FIG. 1;

FIG. 3 shows a further operational block diagram representation of the mobile communications device of FIG. 1;

FIG. 4 shows a diagrammatic view of a user interface screen for event scheduling generated on a display of communications device in an example embodiment;

FIG. 5 shows a diagrammatic view of a menu of schedulable events displayed on a user interface screen;

FIG. 6 shows a diagrammatic view of a communications event entry screen for a telephone call generated on the communications device in an example embodiment;

FIG. 7 shows a diagrammatic view of a reminder screen generated on the communications device in an example embodiment;

FIG. 8 shows a diagrammatic view of a communications event entry screen for an email message generated on the communications device in an example embodiment;

FIG. 9 shows a diagrammatic view of a communications event entry screen for a text message generated on the communications device in an example embodiment;

FIG. 10 shows a diagrammatic view of an email user interface screen;

FIG. 11 shows a diagrammatic view of a text messaging user interface screen;

FIG. 12 shows a diagrammatic view of a communications event entry screen for a conference call generated on the communications device in an example embodiment; and

FIG. 13 shows a diagrammatic view of a further reminder screen generated on the communications device in an example embodiment.

### DETAILED DESCRIPTION

At least one example embodiment includes a method for scheduling communications events on an electronic communications device having a display, a user input device, and a communications module for communicating over a communications network with a target recipient. The method includes (i) storing information about a future communications event, the stored information including stored address information identifying an address of the target recipient and stored time information identifying a scheduled time for the future communications event; (ii) displaying on the display of the communications device, at a time determined in dependence on the stored time information, a notification of the future communications event; (iii) monitoring for a confirmation input through the user input device confirming a user desire to proceed with the future communications event; and (iv) automatically providing the address for the target recipient to the communications module in dependence on the stored address information upon detecting the confirmation input.

At least one example embodiment includes a communications device enabled to communicate over a communications network with other devices. The device includes a display; a user input device; a communications module for communicating over the communications network with other devices; a storage; and a scheduler module (i) storing in the storage information about a future communications event, the stored information including stored address information identifying an address of the target recipient and stored time information identifying a scheduled time for the future communications event; (ii) displaying on the display, at a time determined in dependence on the stored time information, a notification of the future communications event; (iii) monitoring for a confirmation input through the user input device confirming a user desire to proceed with the future communications event; and (iv) automatically providing the address for the target recipient to the communications module in dependence on the stored address information upon detecting the confirmation input.

The following description of one or more specific embodiments does not limit the implementation of the invention to any particular computer programming language, operating system, system architecture or device architecture. Moreover, although some embodiments may include mobile devices, not all embodiments are limited to mobile devices; rather, various embodiments may be implemented within a variety of communications devices or terminals, including handheld devices, mobile telephones, personal digital assistants (PDAs), personal computers, audio-visual terminals, televisions, and other devices.

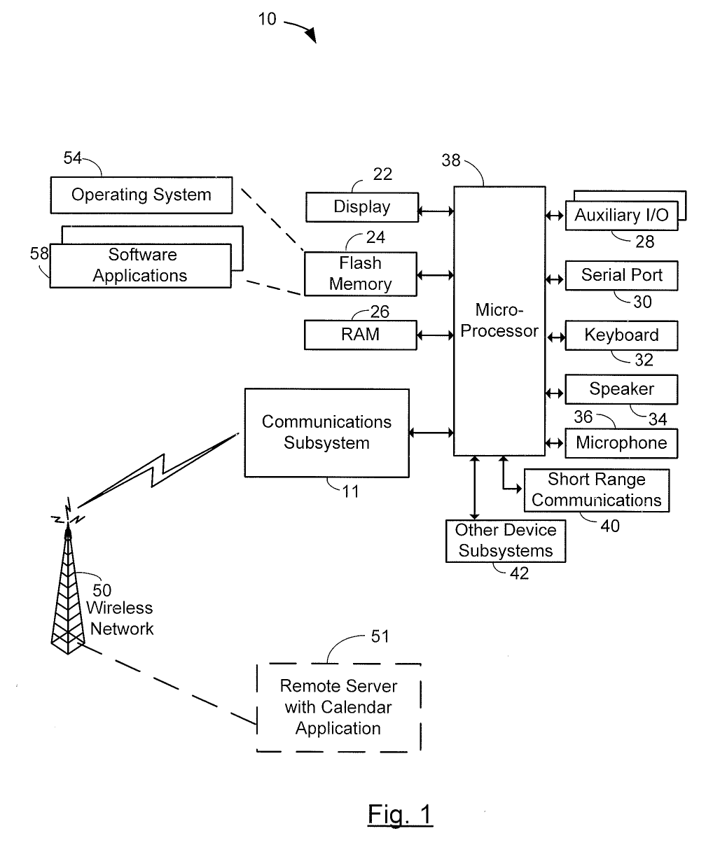

Referring now to the drawings, FIG. 1 is a block diagram showing an example of an electronic communications device 10 to which example embodiments of the communications events scheduler described herein can be applied. The communications device 10 is a two-way mobile communication device having voice and messaging communications capabilities, although in some embodiments a device having only voice or only messaging capabilities is used. Depending on the functionality provided by the device 10, in various embodiments the device 10 may be a data communication device, a multiple-mode communication device configured for both data and voice communication, a mobile telephone, a PDA enabled for wireless communication, a computer system with a wireless modem or wireless network card, or a computer or phone device with a fixed connection to a network, among other things. The device 10 may be a handheld device.

In the example embodiment shown in FIG. 1, the device 10 includes a communication subsystem 11. The communication subsystem 11 may include one or more receivers, transmitters, and associated components such as one or more antenna elements, and a processing module such as a digital signal processor (DSP). As will be apparent to those skilled in the field of communications, the particular design of the communication subsystem 11 will be dependent upon the communication network(s) in which the device 10 is intended to operate.

Signals received by the device 10 from a wireless communication networks 50 are input to the receiver of the communication subsystem 11, which may perform such common receiver functions as signal amplification, frequency down conversion, filtering, channel selection and the like. In a similar manner, signals to be transmitted are processed, including modulation and encoding for example, by the DSP and input to the transmitter for digital to analog conversion, frequency up conversion, filtering, amplification and transmission over the wireless communication network 50.

The device 10 includes a microprocessor 38 that controls the overall operation of the device. The microprocessor 38 interacts with the communications subsystem 11 and also interacts with further device subsystems such as a display 22, flash memory 24, random access memory (RAM) 26, one or more auxiliary input/output (I/O) subsystems or devices 28 (e.g. a thumbwheel 28a), serial port 30, keyboard or keypad 32, speaker 34, microphone 36, a short-range communications subsystem 40, and any other device subsystems generally designated as 42.

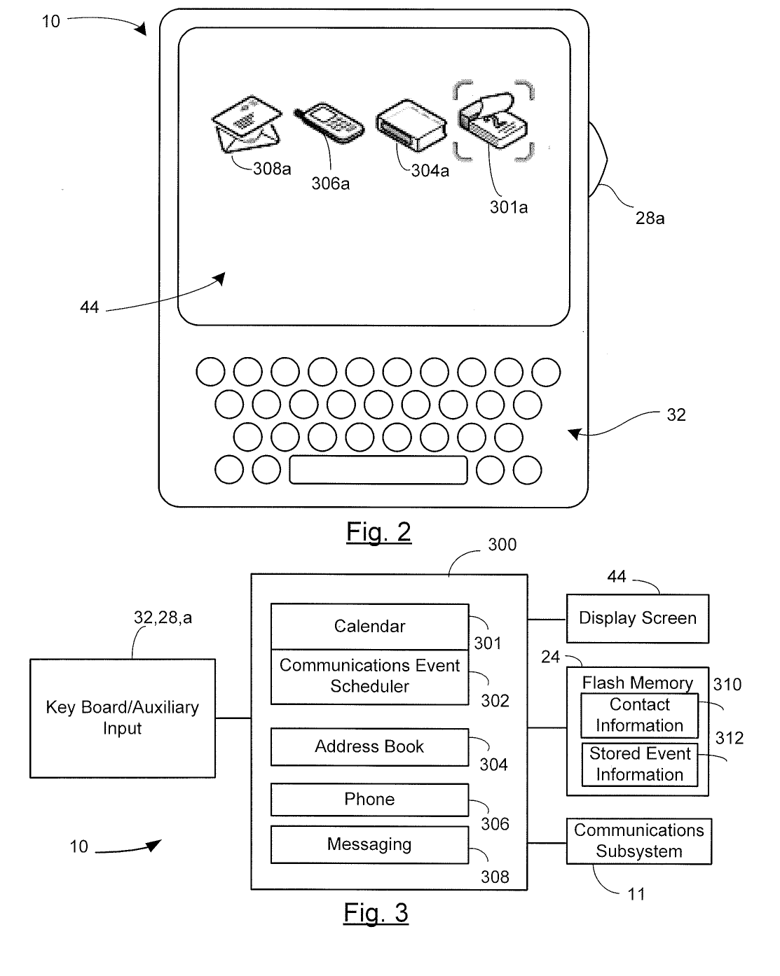

FIG. 2 shows, in diagrammatic form, a front view of an example handheld embodiment of the device 10 of FIG. 1. The device 10 includes a display screen 44 of the display 22, alphanumeric keyboard or keypad 32 and thumbwheel 28a.

Operating system software 54 and various software applications 58 used by the microprocessor 38 are, in one example embodiment, stored in a persistent store such as flash memory 24 or similar storage element. Those skilled in the art will appreciate that the operating system 54, software applications 58, or parts thereof, may be temporarily loaded into a volatile store such as RAM 26. It is contemplated that received communication signals may also be stored to RAM 26.

The microprocessor 38, in addition to its operating system functions, preferably enables execution of software applications 58 on the device. A predetermined set of software applications 58 which control basic device operations, including data and voice communication applications for example, will normally be installed on the device 10 during manufacture. Further software applications 58 may also be loaded onto the device 10 through the wireless communication network 50, an auxiliary I/O subsystem 28, serial port 30, short-range communications subsystem 40 or any other suitable subsystem 42, and installed by a user in the RAM 26 or a non-volatile store for execution by the microprocessor 38. Such flexibility in application installation increases the functionality of the device and may provide enhanced on-device functions, communication-related functions, or both. For example, secure communication applications may enable electronic commerce functions and other such financial transactions to be performed using the device 10.

In a data communication mode, a received signal such as a text message or web page download will be processed by the communication subsystem 11 and input to the microprocessor 38, which will preferably further process the received signal for output to the display 22, or alternatively to an auxiliary I/O device 28. A user of device 10 may also compose data items within a software application 58, such as email messages and calendar entries for example, using the keyboard 32 in conjunction with the display 22 and possibly an auxiliary I/O device 28 (e.g. the thumbwheel 28a). Such composed items may then be transmitted over a communication network through the communication subsystem 11.

The serial port 30 (which may be for example a universal serial bus (USB) port) in FIG. 1 may enable a user to set preferences through an external device or software application and would extend the capabilities of the device by providing for information or software downloads to the device 10 other than through a wireless communication network.

The short-range communications subsystem 40 is a further component which may provide for communication between the device 10 and different systems or devices, which need not necessarily be similar devices. For example, the subsystem 40 may include an infrared device and associated circuits and components or a Bluetooth™ communication module to provide for communication with similarly enabled systems and devices.

Wireless communication network 50 is, in an example embodiment, a wireless wide are packet data network, (e.g. Mobitex™ or DataTAC™), which provides radio coverage to mobile devices 10. Wireless communication network 50 may also be a voice and data network such as GSM (Global System for Mobile Communication) and GPRS (General Packet Radio System), CDMA (Code Division Multiple Access), or various other third generation networks such as EDGE (Enhanced Data rates for GSM Evolution) or UMTS (Universal Mobile Telecommunications Systems). In some example embodiments, network 50 is a wireless local area network (WLAN), such as for example a network compliant with one or more of the IEEE 802.11 family of standards. In some example embodiments, the device 10 is configured to communicate in both data and voice modes over both wireless WAN and WLAN networks and to roam between such networks.

Under instructions from various software applications 58 resident on the device 10, the processor 38 is configured to implement various functional components or modules 300, some of which are represented in FIG. 3, for interacting with the device subsystems described above. In an example embodiment, the software resident on the device 10 includes applications for implementing a communications event scheduler 302, an address book 304, a telephone 306, and an email and/or instant text messaging device 308. In some embodiments, some or part of the functionality of the functional modules 300 can be implemented through firmware or hardware components instead of, or in combination with, computer software instructions executed by the microprocessor 38 (or other processors).

The communications event scheduler 302 is provided for scheduling communications events, displaying reminders to the user of such events, and facilitating initiation of the communications event. Communications events include events where device 10 communicates with one or more third party communications device, including events such as, for example, audio phone calls, video phone calls and electronic messaging including email and instant text messaging and other audio and visual messages. The communications event scheduler 302 may be implemented as part of a general event scheduling application, such as calendar 301 for example. The use of calendar applications on PDA-type devices and personal computers to schedule and provide reminders of general events, such as appointments, meetings, birthdays and the like is common place.

The address book 304 enables contact information, such as telephone numbers and email and/or instant text messaging addresses, to be stored and accessed on the device 10. The phone module 306 enables the device 10 to operate as a voice phone (and in some embodiments as a video phone) over one or more wireless networks 50, The messaging module 308 enables the device 10 to send and receive electronic messages such as email and/or text messages over one or more wireless networks 50.

With reference to FIG. 2, in at least some example embodiments, the modules 300 each have an associated selectable icon that is displayed on the screen 44 as part of a graphical user interface. For example, FIG. 2 shows an icon 301a for calendar 301, an icon 304a for address book 304, an icon 306a for phone 306 and an icon 308a for electronic messaging 308.

According to example embodiments of the invention, the communications event scheduler 302 permits a user of the device 10 to schedule a future communications event, such as a phone call or an electronic message transmission, and associate the upcoming communications event with contact address information such as a phone number or electronic address of one or more target recipients such that when the scheduled time arrives the address information for the one or more target recipients can be automatically supplied to the phone module 306 or messaging module 308 without requiring the user to search for such information.

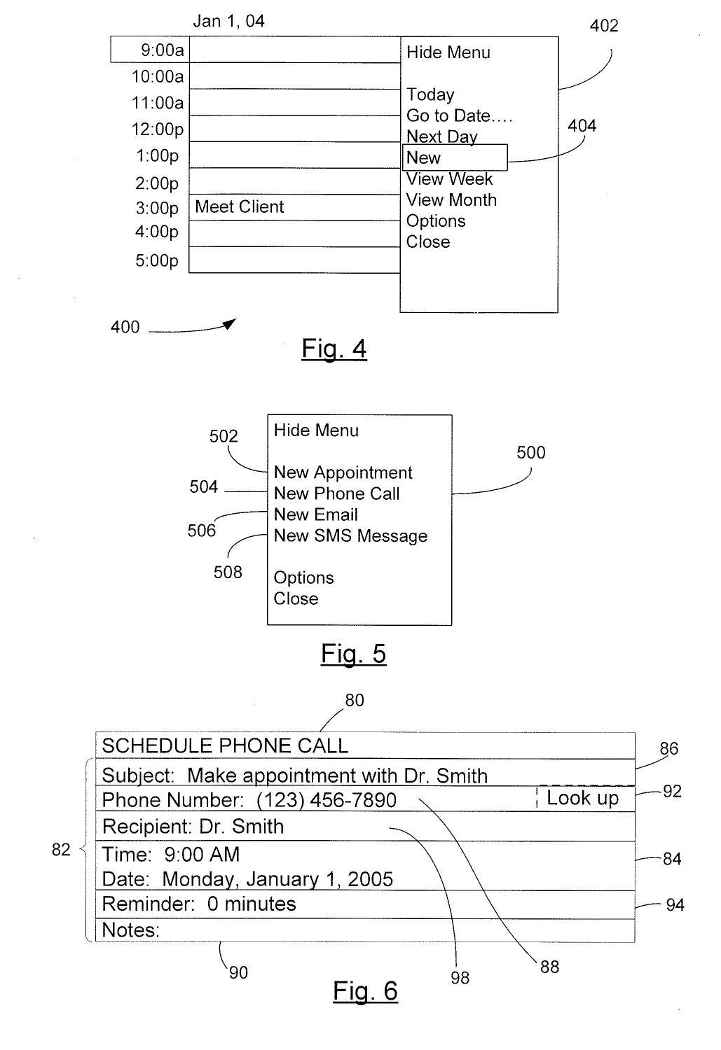

In this regard, reference is now made to FIG. 4 that shows, in diagrammatic form, an illustrative calendar graphical user interface screen 400 generated on screen 44 for displaying scheduled events. The interface screen 400 may be generated in response to user selection of calendar icon 301a or in response to other activity at device 10. The interface screen 400 includes a number of selectable time periods that a user can scroll through (shown as one hour periods in FIG. 4 however periods of longer or shorter selectable durations can be alternatively shown). Once a user selects, via keyboard and/or an auxiliary input device such as thumbwheel 28a, a time period (for example 9:00a), a menu 402 of selectable items appears, including a “new” item 404. Selection of the “new” item 404 generates a further menu 500 shown in FIG. 5, displaying menu items for different types of events that can be scheduled. In an example embodiment, included among the menu items are: “New Appointment” 502 for scheduling a conventional appointment; and “New Phone Call” 504, “New Email” 506 and “New SMS Message” 508 for scheduling future communications events. Although three different communications events are shown in the illustrated embodiment, in some example embodiments, the communications event scheduler 302 is able to schedule a greater range of communications events, and in some embodiments is limited to scheduling only one type of future communications event (for example, voice phone calls). A user of device 10 may scroll through and select menu items from the selection menu 500 using a user input device of device 10—for example, an auxiliary I/O device such as thumbwheel 28a. The selection menu 500 may be displayed in response to other user actions other than through selection of the “new” item in list 402. For example, it may be possible to access menu 500 through other user interfaces.

When the new phone call item 502 is selected, the communications events scheduler 302 will cause the display to present a phone call scheduling interface screen 80, as shown diagrammatically in FIG. 6, allowing the user to enter information in a plurality of fields 82 using the keyboard 32 and/or an auxiliary I/O device 28 such as thumbwheel 28a. In example embodiments, the phone call entry interface screen 80 can be accessed through the address book 304 rather than through calendar 301.

Phone call scheduling screen 80 includes at least a date and time fields 84 associated with the date and time of the scheduled phone call. If the screen 80 is accessed via the calendar 301, the date and time fields 84 may be automatically pre-populated based on the time period selected from screen 400, and subject to editing by the user. Alternatively, the user may enter a specific date and time in the date and time fields 84. In some embodiments, the user may schedule a recurring communications event, for example to schedule a call for 8:30 am every Monday for either a specified or indefinite number of weeks.

The plurality of fields 82 may also include a subject field 86 for indicating the subject or purpose of the appointment and a notes field 90 for making notes for future references. The fields 82 include an intended recipient address field 88, which in the case of a telephone call event is a telephone number, and may include an intended recipient name field 98.

The user may manually enter a telephone number in the recipient address field 88 and may manually enter a name in the name field 98. In some embodiments a “lookup” selection item 92 links the user to a contact information database 310 maintained by the address book module 304 so that the user can lookup a stored contact by entering all or part of the contact's name. When a contact is selected by the user from the address book the name and phone number fields 98, 88 are automatically populated with the relevant information from the address book contact information database 310. In some embodiments, the user can select multiple contacts to whom the communications event should be addressed.

As indicated above, in some embodiments the interface screen 80 can be reached through menus generated by the address book module 304 as an alternative to being accessed through menus generated by the calendar module 301. For example, upon selecting a contact from the address book, the user may be presented with a possible menu item of “Schedule Phone Call” and selecting such item results in the communications event scheduler 102 generating interface screen 80 with the name and phone number fields 98, 88 being pre-populated based on the stored contact information maintained by the address book for the selected contact. In some embodiments, the stored contact information database 310 is stored locally in a storage such as flash memory 24 of the device and periodically synchronized with an address book maintained at a personal computer of the user. In other embodiments, the stored contact information may be retrieved from a remote server or computer over wireless network 50 as part of the lookup function.

In at least one example embodiments, the communications event scheduler 302 will, as discussed in greater detail below, generally attempt to generate a prompt or reminder at the time set in the time and date fields 84. However, as indicated by reminder field 94, the user may request that a reminder be generated at a set duration prior to the scheduled communications event time.

Once a future communications event has been scheduled the information about the event from fields 82 is stored as a record in a scheduled events database 312 maintained by calendar module 301 in a storage (for example flash memory 24) of the device 10. It will appear as a calendar entry at the relevant date and time when a calendar page such as that shown in FIG. 4 is viewed on the device 10. The user can, in some configurations, have the option to view the details of a scheduled future communications event and modify fields 82 or delete the scheduled communication event as desired. In some example embodiments where address book contact information 310 is stored on the device 10 and the intended recipient for the communications event is listed in the address book contact information 310, the stored event information 312 may include a link or pointer to the appropriate address book entry rather than or in addition to directly storing the recipient's address (i.e. phone number in the case of phone call or SMS message, and email address in the case of an email) in the stored event information 312, thus allowing address information that is updated in the address book contact information 310 between the time that the call (or email or SMS message) is first scheduled and then actually made.

It will be appreciated that through interface screen 80 or a similar input screen a record for a scheduled future communications event can be created and stored in scheduled event information database 312. Among other things the stored communication event information identifies a scheduled time (namely a time and date as provided in field 84) and the address of the recipient for the communications event. In some examples, the stored communication event information can identify the recipient's address directly, such as in form of a stored phone number from field 88, and in some example, the recipient's address may be identified indirectly by a link or pointer in the future communications event record to the appropriate address field in a contact information record for the recipient in contact information database 310. Including the recipient's address (either directly or through a link or pointer) obviates the need for the user to have to look for the recipient's address at the time of the scheduled event. In some example embodiments, multiple recipient phone numbers can be included in field 88, if for example a conference call to multiple parties is to be initiated.

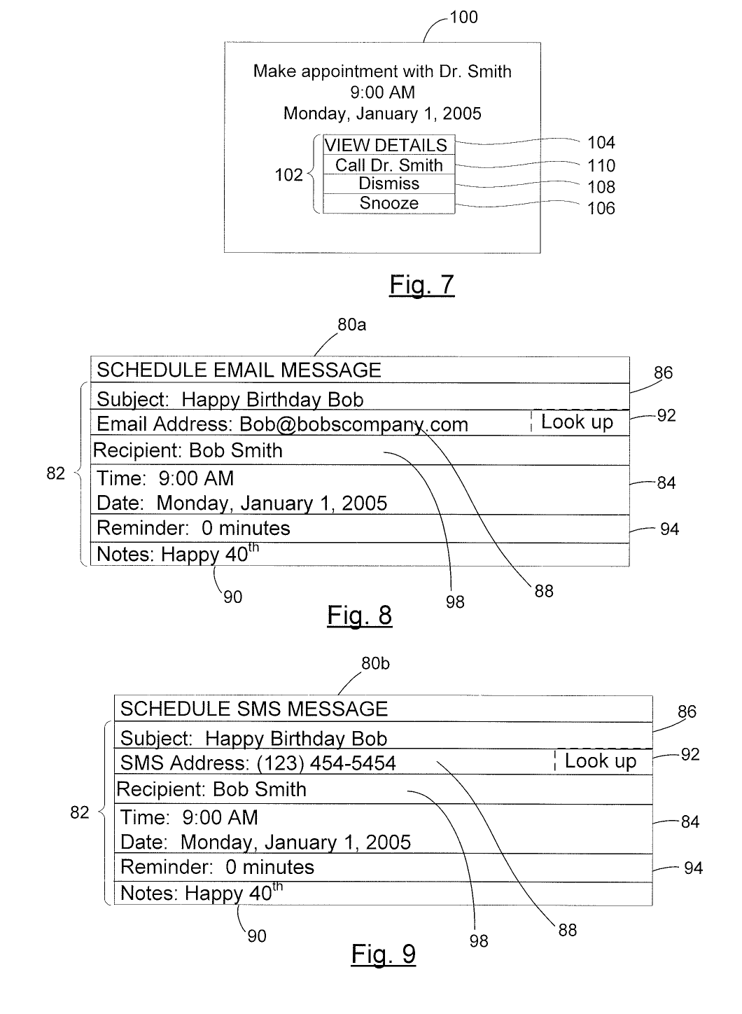

Upon the occurrence of the time for a scheduled communications event, the communications event scheduler causes a reminder to be displayed on screen 44. One example of such a phone call reminder dialog box 100, comprising a plurality of buttons 102, is shown in FIG. 7. The plurality of buttons 102 comprises a details button 104 (designated by “View details”) for viewing the details of the scheduled phone call in an interface screen similar to the phone call entry screenshot 80, a defer button 106 (designated by “Snooze”) for deferring the reminder to a new time and date, a dismiss button 108 (“Dismiss”) for dismissing the reminder, and a call button 110 (“Call”) for executing the scheduled phone call. Optionally, the call button 110 will also display the name or number associated with the call (e.g. “Call Dr. Smith”). The above-listed names for each of the plurality of buttons 102 are intended as examples, and the skilled person will understand that any reasonable name could be used. Likewise, any suitable combination of buttons may be used. Moreover, the plurality of buttons may be replaced with any suitable user interface. As indicated in FIG. 7, the information from the subject field 86 is shown in the dialog box 100, along with the scheduled date and time for the call. In some embodiments, if the device 10 is turned off when the scheduled time occurs, the reminder dialog box 100 is displayed the next time the device is activated. Similar, in some embodiments, if the device 10 is in a locked or inactive state when the scheduled time occurs, the reminder dialog box 100 is displayed when the user next unlocks or activates the device.

The user may select one of the plurality of buttons displayed in dialog box 100 using an auxiliary I/O device 28 such as, for example, the thumbwheel 28a, or the keyboard 32 in conjunction with the display 22.

If the user selects the details button 104, the device 10 will display a screenshot similar to the phone call entry screenshot 80 which presents the information previously entered (as described above) in the plurality of fields 82. If the defer button 106 is selected, the device 10 will exit the phone call reminder dialog box 100 and defer the display of the phone call reminder dialog box 100 to a specified time and/or date. Optionally, the device 10 will present a further date and time field for entry of this specified time and/or date. If the dismiss button 108 is selected, the device 10 will simply exit the phone call reminder dialog box 100.

If the call button 110 is selected, the communications event scheduler 302 automatically passes the intended recipient's telephone number to the phone module 306 and causes the phone module 306 to initiate the communication event over the network 50 by calling the intended recipient's telephone number device 10. Thus, with the selection of a single button 110, the user can execute the pre-scheduled telephone call without having to search for or enter a telephone number. In some embodiments, the dialog box 100 is configured such that the call button 110 is automatically focused when box 100 is generated such that depression of the thumbwheel 28a or other single action user input will result in execution of the scheduled phone call. The call is executed by the phone module 306 over the wireless communications network 50 via the communications subsystem 11. In the case of multiple numbers used for a conference call, in an example embodiment the phone module 306 and event scheduler module 302 are collectively configured to connect to each of the identified numbers sequentially until all parties are connected.

It should be understood that while in the above description, the entering of information, selection of items, etc is performed using the device 10, these tasks could alternatively be performed using a computer, for example a desktop computer, in communication with the device 10.

As indicated above, at least some embodiments facilitate scheduling of other types of communications events such as a future email message or text messaging such as SMS (Short Message Service) or IM (Instant Messaging) text messaging. For example, selecting the menu item “New Email” 506 from the menu of FIG. 4 in an example embodiment will result in the communications event scheduler generating an email scheduling interface screen 80a (FIG. 8), and selecting the menu item “New SMS Message” will result in the communications event scheduler generating an text messaging scheduling interface screen 80b (FIG. 9). The operation of email scheduling and SMS text messaging on device 10 is similar to phone scheduling discussed above. For email addressing, one difference is that the address field 88 for an email message will include an email address rather than a phone number. For a text message, the address field 88 will typically include a Mobile Station ISDN Number (MSISDN), which will typically be a mobile phone number. As with phone scheduling interface screen 80, in example embodiments Email scheduling screen 80a and SMS scheduling screen 80a each include at least a date and time field 84 associated with the date and time of the scheduled communications event, and if the screen 80a or 80b is accessed via the calendar 301, the date and time fields 84 may be automatically pre-populated based on the time period selected from screen 400, and subject to editing by the user. The “lookup” selection item 92 links the user to a contact information database 310 maintained by the address book module 304 so that the user can lookup a stored contact by entering all or part of the contact's name. When a contact is selected by the user from the address book the name and address (email address in the case of an email, MSISDN in the case of an SMS message) fields 98, 88 are automatically populated with the relevant information from the address book contact information database 310.

As with the telephone scheduling screen 80, in some embodiments the email and text messaging scheduling interface screens 80a, 80b can be reached through menus generated by the address book module 304 as an alternative to being accessed through menus generated by the calendar module 301. For example, upon selecting a contact from the address book, the user may be presented with a possible menu item of “Schedule Email Message” or “Schedule SMS Message” and selecting such item results in the communications event scheduler 102 generating interface screen 80a or 80b with the name and email address fields 98, 88 being pre-populated based on the stored contact information maintained by the address book for the selected contact.

As with schedule phone messages, upon the occurrence of the time for a scheduled email or text message event, the communications event scheduler 302 causes a reminder to be displayed on screen 44 such as shown in FIG. 7, with the menu item or button 110 displaying “email” or “SMS” or similar indicator as appropriate in place of “call”.

In the case of an email message, in an example embodiment, if the “email” button 110 is selected, the communications event scheduler 302 automatically passes the intended recipient's email address information to the messaging module 308 and causes the messaging module to display an email message compose interface screen 120 on display screen 144. The email message compose interface screen 120 may be a conventional email composition interface and include an address field 122, a subject field 124, and a message field 126. In an example embodiment, the address field 122 is automatically populated based on address information passed to the messaging module 308 from the communications event scheduler 302. Additionally, in at least some example embodiments, the subject field 124 is automatically populated with the subject information from field 86 of the scheduled communications event record, and the message field 126 is automatically populated with the notes information from field 90 of the communications event record. The user may edit the fields of the email compose interface screen 120. In an example embodiment, a user can use an input device of the mobile device 10 to call a drop-down menu 128, and select a “send email” menu item 129 to cause the messaging module 308 to send the email message over the network 50. Thus, with the selection of a single button 110, the user can enter an email composition screen automatically populated with address and/or other information. In some embodiments, a plurality of email addresses may be populated into the address field for emailing a group at a scheduled time.

In the case of an SMS or other text message, in an example embodiment, if the “email” button 110 is selected, the communications event scheduler 302 automatically passes the intended recipient's address information to the messaging module 308 and causes the messaging module to display a test message compose interface screen 130 on display screen 144. The text message compose interface screen 130 may be a conventional SMS text messaging composition interface and include an address field 132, and a message field 134. In an example embodiment, the address field 122 is automatically populated based on address information passed to the messaging module 308 from the communications event scheduler 302. Additionally, in at least some example embodiments, the message field 134 is automatically populated with the subject information from field 86 of the scheduled communications event record. The user may edit the fields of the text message email compose interface screen 130. In an example embodiment, a user can use an input device of the mobile device 10 to call a drop-down menu 136, and select a “send SMS” menu item 138 to cause the messaging module 308 to send the SMS message over the network 50. Thus, with the selection of a single button 110, the user can enter a text message composition screen automatically populated with address and/or other information.

In the above examples, records for future communications events are stored in a scheduled event information database 312 that is maintained by the device 10 at which the event was first scheduled. In some example embodiments, the future communications event information may be shared with one or more other parties whom are anticipated to participate in the communications event. By way of example, in the case of a scheduled future phone call, video phone conference, email, instant text messaging or other text messaging, it may be desirable to send the future event information (including address information) to all participating parties so that other person(s) can be reminded to be available at the appropriate time, and/or be provided with the address information required to initiate or join into the communications event at the scheduled time.

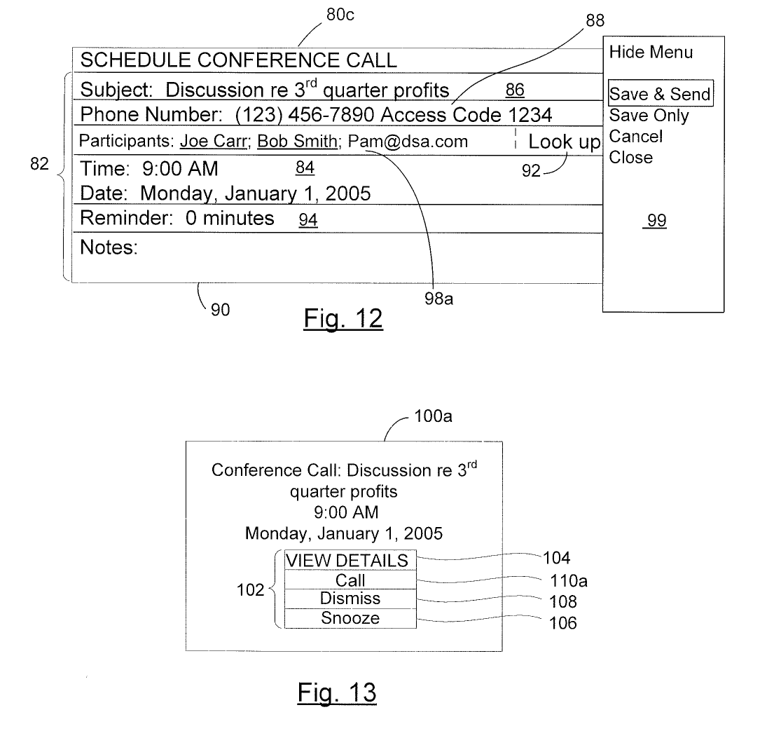

By way of example, the user of device 10 may want to schedule a multi-party conference call at a future time in which the participants each call a dedicated conference call number and enter a conference call access code. In this regard, FIG. 12 illustrates a conference call scheduling interface screen 80c that is somewhat similar to interface screens 80, 80a and 80b discussed above, but with differences that will be apparent from the following description. The interface screen 80c may in some example embodiments be rendered by the communications events scheduler 302 in response to user selection of a “Schedule New Conference Call” option provided as a further option for example in menu 500 of FIG. 5; alternatively, selection of the “New Phone Call” option 504 in FIG. 5 could cause an intermediate user selectable options of “Conference Call” or “Single Party Call” to appear on the device screen, with user selection of “Conference Call” then resulting in interface 80c of FIG. 12, and user selection of “Single Party Call” resulting in interface 80 of FIG. 6. The conference call interface 80c could also be reached through other user interfaces, including for example from an options list displayed in association with an address book entry, or from within an options list displayed in association with a received email or other electronic message.

In an example embodiment, the address field 88 for the conference call scheduling interface 80c can include a centralized conference call number that the participant's are each to call at the scheduled time (set out in date and time fields 84). The address field can also include an access code that has to be entered to participate in the conference call after the conference call telephone number has been dialed. The conference call number and/or access code may be manually entered into field 88, or could for example be automatically populated into the field from information contained in an electronic message received from a conference call facilitating service. In the conference call scheduling interface, the “Recipient” field 98 is replaced with a “Participants” field 98a, which includes information identifying the person scheduling the call, as well as each of the invited participants. At least some of the identified participants have associated electronic address information either entered directly in the “participants” field 98a, or stored in the contact information the device 10. A “Look Up” function 92 can be associated with the “participants” field 98 to look up electronic message addresses for contacts stored in the contact information accessible to the device 10.

Once the desired fields in scheduling interface 80c have been populated, the device user can press a predetermined key (for example depressing a thumb-wheel) to call a drop-down menu 99 listing various menu items including a “Save & Send” option which when selected will save the future conference call event information collected in the fields of interface 80c to the stored event information database 312 on the device 10, as well as, substantially at the same time or shortly after saving the information at device 10, also send the future conferences call event information electronically to each of the identified participants for which electronic address information is known or otherwise available to the scheduling device 10. In some embodiments, the event information can be sent in, or as an attachment to, an email, or as a text message, to the electronic addresses associated with the participants.

The participant's respective communications devices (which can be similar to device 10) can be configured to extract (either with or without requiring the approval of the receiving device user) the scheduling information, including time, date, address information (e.g. conference call number and/or access code) and any other desired information from the received electronic message, and store such information in the stored event information databases 312 of the respective receiving participant devices. Thus, each of the participant devices are then enabled to also generate an appropriate conference call reminder prior to or at the scheduled conference call time, with an option to call the conference call number. By way of example, FIG. 13 shows an example of a conference call reminder dialog box 100a, that is similar to the reminder box 100 of FIG. 7. A reminder box similar to box 100a will in example embodiments be displayed at each of the participant's communications devices that are suitably configured and with which the conference call scheduling information has been previously shared.

A plurality of user selectable buttons 102 comprises a details button 104 (designated by “View details”) for viewing the details of the scheduled conference call in an interface screen similar to the interface 80c of FIG. 12, a defer button 106 (designated by “Snooze”) for deferring the reminder to a new time and date, a dismiss button 108 (“Dismiss”) for dismissing the reminder, and a call button 110a (“Call”) for calling the scheduled conference call number. As will be appreciated, the plurality of buttons may be replaced with any suitable user interface. As indicated in FIG. 13, the information from the subject field 86 is shown in the dialog box 100a, along with the scheduled date and time for the call. In some embodiments, if the device 10 is turned off when the scheduled time occurs, the reminder dialog box 100a is displayed the next time the device is activated. Similarly, in some embodiments, if the device 10 is in a locked or inactive state when the scheduled time occurs, the reminder dialog box 100a is displayed when the user next unlocks or activates the device. In some embodiments, if the scheduled conference call time has already passed, the user is simply presented with a notice that the call time has passed, and is not given the option to join the call.

If the call button 110a is selected, the communications event scheduler 302 automatically passes the conference call number to the phone module 306 and causes the phone module 306 to initiate the communication event over the network 50 by calling the number. In some example embodiments, the communications event scheduler 302 and the phone module 306 are collectively configured so that the access code is also automatically entered after a connection to the conference call phone number has been established. Thus, with the selection of a single button 110a, the user can execute the pre-scheduled conference call without having to search for or enter a telephone number or access code. In some embodiments, the dialog box 100a is configured such that the call button 110a is automatically focused when box 100a is generated such that depression of the thumbwheel 28a or other single action user input will result in execution of the scheduled phone call. The call is executed by the phone module 306 over the wireless communications network 50 via the communications subsystem 11. Video conference calls could be scheduled in a similar manner.

Although the above example related to sharing information concerning an upcoming conference call among the participating parties, other types of scheduled event information can also be shared. For example, each of the phone call, email and text messaging scheduling interfaces 80, 80a and 80b could have an associated “Save & Send” option whereby the communications event information collected in the respective interfaces 80, 80a, or 80b could be sent to the one or more other identified participating parties, and each of the receiving participating party's devices could then store a respective future communications event reminder (including address information for the other participating parties that could be used to automatically populate an address field at the appropriate time).

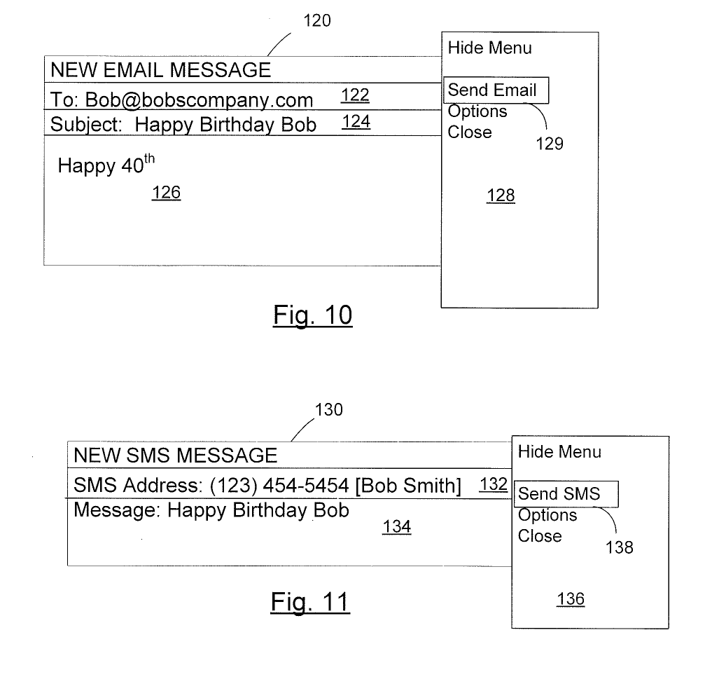

By way of further example, two persons (Person A and Person B) may tentatively agree that they should exchange emails at a future time to set up a lunch date. Using email scheduling interface 80a, Person A enters information for a future email event for emailing to Person B, and then selects a “Save and Send” option which causes: (a) a future email event record, including time, subject information and identification information for Person B (such identification information either including Person B's email address or information linking to Person B's email address), to be stored in the stored event information database 312 of Person A's device 10; and (b) an electronic message about the future email event to be sent to Person's B device, including time, subject information and identification information for Person A (such identification information either including Person A's email address or information linking to Person A's email address). Person B's device can then use the received information to also create an appropriate record in the stored event information database 312 of Person B's device 10. At the scheduled reminder time, at both Person A's and Person B's respective devices 10, a reminder message with an option to send an email (with the address field automatically populated as discussed above with respect to FIG. 10 for example) will be generated, hopefully resulting in at least one of Party A or Party B taking the initiative to mail an email to the other. It will be appreciated that the above example could be extended to more that two participating parties, and also to other forms of electronic messaging including text messaging such as SMS and IM.

In the above described embodiments in which event scheduling information is shared, the information is included in electronic messages sent from a scheduling device of one participant to the devices of other participants. However, in some embodiments, all or some of the scheduling information could be stored at a shared location, such as a remote server 51 (see FIG. 1), accessible to all or multiple participants through one or more communications networks (including for example the Internet). By way of example, the future event scheduling information (including time, date, subject information, type of communications event, participant addresses, etc) could be made available through a shared calendar application that each of the participants have access to, such as for example a Google™ calendar. In various embodiments, the scheduling information can be provided to each of the participating devices 10 from the remote server 51 in different ways—for example, when new or updated scheduling information is stored at the remote server by one participating device 10 for a particular communications event, the scheduling information can then be pushed out from the remote server 51 to each of the other participating devices 10 that are identified in the scheduling information. Such pushing of scheduling information could occur at predetermined intervals, and/or when the communications event is first created or updated at the remote server 51 calendar. Only a portion of the scheduling information may be pushed to the participating devices, or only a notification that an new event has been scheduled or that an existing event has been changed may be pushed to the participating devices, and the devices 10 can each then retrieve from server 51 whatever portions of the scheduling information is required by the device 10 at a given time. In some embodiments, devices 10 periodically poll the remote server 51 for new or updated scheduling information. In some embodiments where a remote server 51 having a shared calendar application is employed, the devices 10 each store their own representation of all or part of the future communications event information in their own respective stored event information database 312 (including for example at least one of participant addresses, time, date or subject information), and at the predetermined reminder time, a communications event reminder such shown in FIG. 7 is rendered at each respective participating device 10 with an selectable option 110 (Call or Email or SMS as appropriate), and selection of the selectable option 110 resulting in automated population of an address field for a communications module on the device 10. In some embodiments, at least some of the information used in the event reminder rendered on the device 10 at the appropriate reminder time or provided to the relevant communications module of the device is received from the remote server 51 at the time that the information is actually required by the device 10 for use in the event reminder or subsequent population of fields required by a communications module that is implementing the communications event.

In one example embodiment, when viewing a received electronic message such as an email message or an SMS message, the device user is given an option to schedule different types of future communications event using information extracted from the electronic message. By way of example, when viewing an incoming email message a drop down options menu can be displayed showing one or more options similar to those shown in FIG. 5—“New Phone Call” 504; “New Email” 506; “New SMS Message” 508, and other communications events options such as “New Conference Call”; “New IM”; “New Video Conference”. Selection of each of the options results in a respective communications event scheduling interface being rendered, such as shown in FIGS. 6, 8, 9 or 12 for example, with information being extracted from the received email to automatically populate fields of the communications event interface that is displayed. For example, if the user selected the “New Phone Call” option, the interface 80 of FIG. 6 could be displayed with the subject line from the incoming email used to populate subject field 86. In one example embodiment, if the party sending the email has an associated address book entry in the contact information database 310 that is stored on the receiving, phone number information for that party taken from the contact information database can be sued to populate phone number field 88. Alternatively, phone number information could be extracted from the email itself, including for example from an accompanying virtual card (.vcf file for example), or from a phone number recognized within the text of the email body. Where multiple phone number options exist, the user of device 10 can be presented with a list of possible options to select, or alternatively an automated selection algorithm could be applied, to arrive at the number to use in field 88. Recipient name filed 98 could also be populated based on the party sending the email. In some example embodiments, the email body could also be scanned for time and date information to sue for populating date and time field 84.

Using similar techniques, information from an incoming email could be used to populate the interface 80a for a future email event; to populate the interface 80b for a future SMS event (again, SMS address information could be retrieved from contact information based on the sender's email address, or extracted from the email itself); to populate the interface 80c for a future conference call; or to populate the information fields for the other types of communications events identified above. Similarly, information contained in incoming text messages, such as an SMS message for example, could be used to populate the information fields (including address, subject, recipient, etc) for future phone events; email events; SMS events, IM events, video conference events, and teleconference events, among others. Thus, information that is received through one type of communications medium can be used by the device 10 to schedule a communications event using a different communications medium.

While the invention has been described in detail in the foregoing specification, it will be understood by those skilled in the art that variations may be made without departing from the scope of the invention, being limited only by the appended claims.

What is claimed is:

1. A method for scheduling electronic message events on an electronic communications device having a display, a user input device, and a communications module for communicating over a communications network with a target recipient, the method comprising:
storing information about an electronic message event, the stored information including stored address information identifying an address of the target recipient and stored time information identifying a scheduled time for the electronic message event;
displaying on the display of the communications device, at a time determined in dependence on the stored time information, a notification of the electronic message event;
monitoring for a confirmation input through the user input device confirming a user desire to proceed with the electronic message event;
generating on the display, upon detecting the confirmation input, a message composition user interface for composing an electronic message and having a electronic message address field that is automatically populated with an electronic message address for the target recipient based on the stored address information.

2. The method of claim 1 comprising, prior to storing the stored information, displaying on the display a message scheduling interface screen comprising an address field for entering address information, a time field for entering time information, and at least one further field for entering text, wherein the stored address information and the stored time information are based on the address information entered in the address field and time field, respectively, of the message scheduling interface screen, and wherein text information is stored based on the text entered in the further field, the method including, when generating the message composition user interface automatically populating a text entry field thereof with the stored text information.

3. The method of claim 2 wherein the electronic message is an email message, the electronic message address comprises an email address, and the text entry field of the message composition user interface comprises at least one of a subject line field or a message body field.

4. The method of claim 2 wherein the electronic message is a text message, the electronic message address includes a phone number of the target recipient, and the text entry field of the message composition user interface comprises a text message field.

5. The method of claim 1 comprising displaying information about the electronic message event in a calendar display on the display in a time location corresponding to the stored time information.

6. The method of claim 1 wherein the communications device is a wireless communications device and the communication network comprises a wireless network.

7. The method of claim 1 comprising prior to storing the stored information, receiving at the electronics communications device from a further communications device a first message and determining the target recipient and time information in dependence on the first message.

8. The method of claim 7 wherein the first message belongs to one type of communications medium and the electronic message belongs to another type of communications medium.

9. The method of claim 8 wherein one of the first message and the electronic message is an email message and the other of the first message and the electronic message is a text message.

10. The method of claim 1 including sending to the target recipient when the stored information is stored or shortly thereafter, a message including at least some of the stored information is transmitted to the target recipient.

11. The method of claim 1 wherein at least some of the information about the message event is stored on a storage of the communications device.

12. The method of claim 1 wherein at least some of the message event information is stored at a remote server having shared calendar application, the method including receiving message event information at the electronic communications device over the communications network from the remote server.

13. A communications device enabled to communicate over a communications network with other devices, comprising:
a display;
a user input device;
a communications module for communicating over the communications network with other devices;
a storage; and
a scheduler module (i) storing in the storage information about a future electronic message event, the stored information including stored address information identifying an address of a target recipient and stored time information identifying a scheduled time for the future electronic message event; (ii) displaying on the display, at a time determined in dependence on the stored time information, a notification of the future electronic message event; (iii) monitoring for a confirmation input through the user input device confirming a user desire to proceed with the future electronic message event; and (iv) automatically providing the address for the target recipient to the communications module in dependence on the stored address information upon detecting the confirmation input.

14. The device of claim 13 wherein the communications module comprises an electronic messaging module, and the address includes an electronic messaging address for the target recipient, the scheduler module generating on the display, upon detecting the confirmation input, the electronic messaging module generating a message composition user interface for composing an electronic message and having a electronic message address field that is automatically populated with the electronic messaging address based on the stored address information.

15. The device of claim 14 wherein the scheduler module, prior to storing the stored information, displays on the display a message scheduling interface screen including an address field for entering address information, a time field for entering time information, and at least one further field for entering text, wherein the stored address information and the stored time information are based on the address information entered in the address field and time field, respectively, of the message scheduling interface screen, and wherein text information is stored based on the text entered in the further field, the electronic messaging module, when generating the message composition user interface, automatically populating a text entry field thereof with the stored text information.

16. The device of claim 15 wherein the electronic message is an email message, the electronic message address includes an email address, and the text entry field of the message composition user interface includes at least one of a subject line field or a message body field.

17. The device of claim 15 wherein the electronic message is a text message, the electronic message address includes a phone number of the target recipient, and the text entry field of the message composition user interface includes a text message field.

18. The device of claim 13 wherein the communications device is a wireless communications device and the communication network includes a wireless network.

19. A computer program product having a computer-readable medium tangibly embodying computer executable instructions for scheduling a electronic message event on a communications device, the instructions comprising instructions for:
storing at the communications device information about a future electronic message event, the stored information including stored address information identifying an address of the target recipient and stored time information identifying a scheduled time for the future electronic message event;
displaying on a display of the communications device, at a time determined in dependence on the stored time information, a notification of the future electronic message event;
monitoring for a confirmation input through a user input device confirming a user desire to proceed with the electronic message event;
automatically providing the address for the target recipient to the communications module in dependence on the stored address information after detecting the confirmation input.

20. A method for scheduling communications events on an electronic communications device having a display, a user input device, and a communications module for communicating over a communications network with a target recipient, the method comprising:
receiving at the communications device over the communications network information about a communications event, the communications event information including address information identifying an address of a target recipient and time information identifying a scheduled time for the communications event;
displaying on the display of the communications device, at a time determined in dependence on the time information, a notification of the communications event;
monitoring for a confirmation input through the user input device confirming a user desire to proceed with the communications event;
automatically providing the address for the target recipient to the communications module in dependence on the address information upon detecting the confirmation input.

21. The method of claim 20 wherein the communications event is a phone call, the communications module includes a phone module enabled for establishing phone calls over the communications network, the address including a phone number of the target recipient.

22. The method of claim 20 wherein the communications event is an electronic message.

23. The method of claim 20 wherein the communications information is received from a further communications device that is scheduled to participate in the communications event.

24. The method of claim 20 wherein the communications information is received from a remote server having a shared calendar application.

25. A method for scheduling a conference call on an electronic communications device having a display, a user input device, and a communications module for communicating over a communications network with a target recipient, the method comprising:
storing at the communications device information about a future conference call the stored information including a phone number for the conference call and stored time information identifying a scheduled time for the conference call;
displaying on the display of the communications device, at a time determined in dependence on the stored time information, a notification of the conference call;
monitoring for a confirmation input through the user input device confirming a user desire to proceed with the conference call;
automatically initiating a connection to the phone number upon detecting the confirmation input.
